(19) United States
(12) Patent Application Publication
(10) Pub. No.: US 2023/0124742 A1
(43) Pub. Date: Apr. 20, 2023

(54) CUTTING TOOL, IN PARTICULAR FOR CUTTING FLAT FOODSTUFFS

(71) Applicant: Ivica VRDOLJAK, Klagenfurt (AT)

(72) Inventor: Ivica VRDOLJAK, Klagenfurt (AT)

(21) Appl. No.: 17/906,111

(22) PCT Filed: Feb. 5, 2021
(86) PCT No.: PCT/AT2021/060043

§ 371 Date: Sep. 12, 2022

(30) Foreign Application Priority Data
Mar. 13, 2020 (AT) A 50215/2020

(51) Int. Cl. B26B 13/16

(52) U.S. Cl. CPC B26B 13/16

(57) ABSTRACT

A cutting tool, in particular for cutting flat foodstuffs, including a first cutting element and a second cutting element, which is mounted on the first cutting element so as to be pivotable about an axis of rotation. The first cutting element has an upper blade and a handle between which the axis of rotation is arranged, and the second cutting element has a lower blade and a handle-free end region between which the axis of rotation is arranged. The cutting tool also has a spring element which is fastened at a first end to the upper blade and at a second end to the lower blade and spreads apart the first cutting element and the second cutting element into a predetermined rest position. The spring element is guided partially around the end region of the second cutting element.

The invention relates to a cutting tool, in particular for cutting flat foodstuffs, comprising a first cutting element and a second cutting element, which is mounted on the first cutting element so as to be pivotable about an axis of rotation, wherein the first cutting element has an upper blade and a handle between which the axis of rotation is arranged, and the second cutting element has a lower blade and a handle-free end region between which the axis of rotation is arranged, wherein the cutting tool also has a spring element, which is fastened at a first end to the upper blade and at a second end to the lower blade and spreads apart the first and the second cutting element into a predetermined rest position.

From AT 395 837B there is known a knife for dissecting flat foodstuffs. In this solution, an edge is formed integrally with a handle and a blade is connected in an articulated manner to the edge. There is further provided a spring, which pushing the blade away from the edge into a rest position. In order to dissect the flat foodstuff, the blade is guided underneath the foodstuff and the edge is positioned above the foodstuff. By pushing the edge towards the foodstuff, this is then dissected. By reducing the pressure onto the edge, this is then pushed away from the blade, whereby the knife may then be advanced to dissect the next part of the foodstuff.

The spring of this knife is fastened to the edge as well as to the blade and is supported on a bolt, which connects the edge to the blade in an articulated way. This is disadvantageous as the spring rests upon the blade. The thickness of the knife at this point is, hence, defined by the spring, the blade and the edge arranged behind. With this arrangement, the knife is thus very thick in the region of the blade, whereby foodstuff residues may easily enter the gap between spring and blade, resulting in a malfunction of the knife.

From non-generic prior art of AT 519 779 A2 dealing with cutting tools having two handles, it has been known to use a curved spring element for spreading apart the two handles and, hence, the two edges. Also in this embodiment, the spring element rests upon an edge or upon a handle, respectively, such that the thickness is a result of the spring and the two edges arranged one behind the other.

This embodiment, hence, has the same disadvantages as the knife of AT 395 837 B.

Further disadvantages occurring with both embodiments of prior art are loud noise while cutting with the knife or the cutting tool, respectively.

It is thus the task of the invention to provide a single-handle cutting tool, which is configured rather slim in the region of the spring element and, hence, is less prone to failure. The cutting tool further should enable a possibly noise-free operation.

This task is solved by a cutting tool, in particular a cutting tool for cutting flat foodstuffs, comprising a first cutting element and a second cutting element, which is mounted on the first cutting element so as to be pivotable about an axis of rotation, wherein the first cutting element has an upper blade and a handle between which the axis of rotation is arranged, and the second cutting element has a lower blade and a handle-free end region between which the axis of rotation is arranged, wherein the cutting tool also has a spring element, which is fastened at a first end to the upper blade and at a second end to the lower blade and spreads apart the first cutting element and the second cutting element into a predetermined rest position, wherein the spring element is guided at least partially around the end region of the second cutting element, and wherein the spring element offers a lower resistance via a first cutting region to a cutting motion of the lower blade than via a second cutting region, wherein the first cutting region is situated between the rest position of the second cutting element and a predetermined angle and the second cutting region is situated between the predetermined angle of the second cutting element and the closed position of the second cutting element.

This solution makes it possible that the spring element is guided in a region behind the second cutting element and does not rest thereupon such that the cutting tool in total has a lower thickness. Furthermore, the cutting tool is also not prone to foodstuff residues entering the gap between the spring element and the second cutting tool, whereby the number of malfunctions is being reduced.

A particular problem of prior art is that usually there is developed noise with every cut using the cutting tool known. This is the result of initially being situated, for example, hard bread or the like between the upper blade and the lower blade. Once the pressure applied using the cutting tool is sufficiently large, the hard bread will be cut through and the lower blade and the upper blade will be rapidly pressed together, whereby the two blades approximate one another at a high speed. The lower blade impacts, in this way, on a stop bolt or on another stopper, whereby noise occurring will be also transmitted via the blades onto a plate situated underneath. When cutting with the cutting tool known, there will furthermore arise a very loud and—in domestic use—also annoying noise. In order to overcome this problem, the spring element according to the invention offers a lower resistance via a first cutting region to a cutting motion of the lower blade than via a second cutting region, wherein the first cutting region is situated between the rest position of the second cutting element and a predetermined angle and the second cutting region is situated between the predetermined angle of the second cutting element and the closed position of the second cutting element. Due to the large resistance before the contact of the two blades, the relative speed of the two blades towards one another will be reduced and the impact speed of the blades will be reduced. If the resistance is sufficiently high, impact of the blades may even be prevented, thus no noise will occur at all.

In the embodiment mentioned above, the spring element may, for example, be configured accordingly, e.g. in a curved way, in order to obtain the variable resistance. Especially preferably, however, the spring element assumes in the first cutting region a distance to the end region and abuts to the end region in the second cutting region. This enables a particularly simple embodiment in order to provide for the variable resistance.

It is preferred that the spring element be guided around the entire end region and, for example, only rest upon the lower blade in the region of a fastening point of the spring element or not at all. With this solution, the spring element is guided in particular in the region of the handle next to the axis of rotation behind the end region, such that the spring is accommodated in this region behind the end region.

In order to further reduce the occurrence of undesired noise, the spring element may be fastened at the upper blade in a way such that the lower blade abuts to the spring element in the closed position of the second cutting element. The spring element in this embodiment prevents direct impact of the lower blade onto a bolt or the like. Even if the spring element is made from metal, this will act as additional cushioning. An especially simple realization of this embodiment is if the spring element is fastened to the upper blade using a bolt and if the spring element in the closed position of the second cutting element is situated between the lower blade and the bolt.

In order to prevent the spring element from sliding off of the end region, there may be provided in particular two alternative embodiments. In the first preferred embodiment, the end region of the second cutting element has a chamfering, by means of which the spring element is held at the end region. In the second preferred embodiment, the end region of the second cutting element has a groove, by means of which the spring element is held at the end region. These two embodiments provide for securing the spring element without any additional auxiliary means such as clamps and, hence, are very insusceptible to failure.

The lower blade has preferably a nose facing away from the axis of rotation at the end face, which in the closed position of the second cutting element projects preferably beyond the upper blade. If foodstuff residues enter the gap between the two blades and prevent opening of the cutting tool, the nose may be used to separate the two blades, without the blades having to be manually separated from one another.

As the cutting tool is to be preferably used for cutting foodstuff, there is preferably provided that the lower blade has a length of up to 12 cm. Larger lower blades are not suitable for domestic use.

Advantageous and non-limiting embodiments of the invention will be explained in greater detail below by way of the drawings.

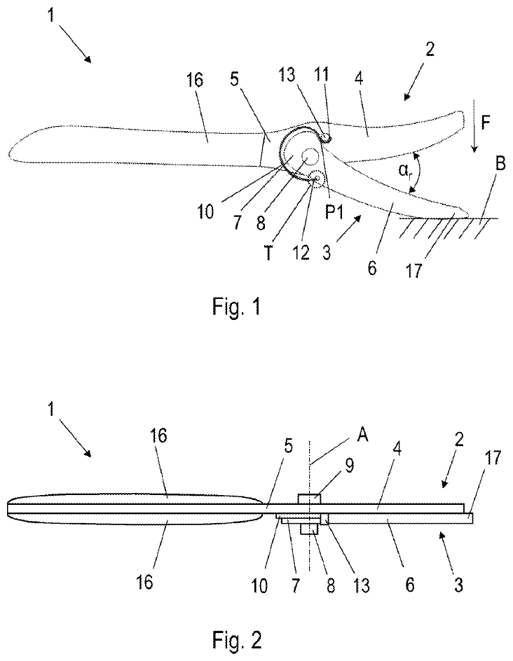

FIG. 1 shows a cutting tool according to the invention having an opened lower blade.

FIG. 2 shows the cutting tool of FIG. 1 in a top view.

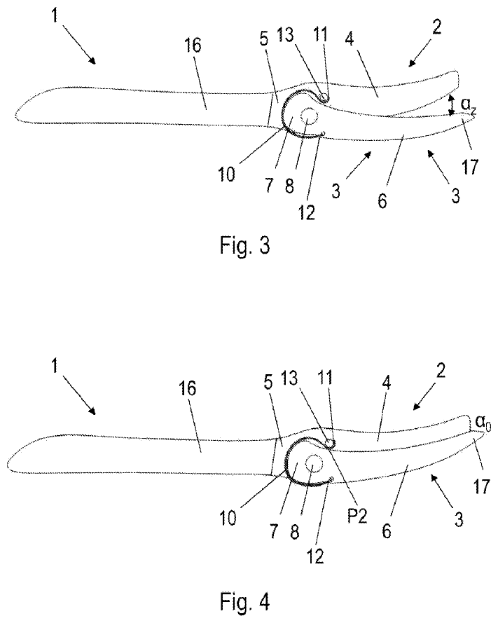

FIG. 3 shows the cutting tool of FIG. 1, wherein the lower blade is at a predetermined angle to the upper blade.

FIG. 4 shows the cutting tool of FIG. 1 having a closed lower blade.

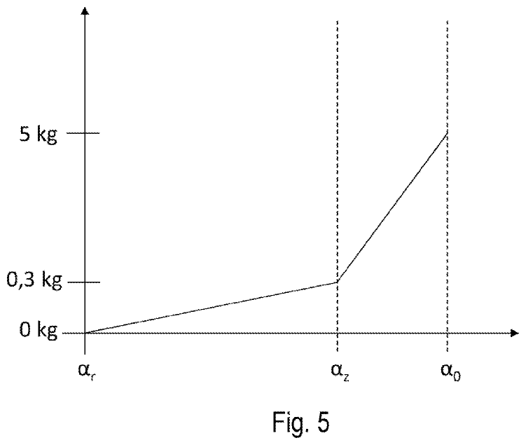

FIG. 5 shows a diagram, in which the opening angle of the lower blade is indicated on the x-coordinate and a required spring force is indicated on the y-coordinate.

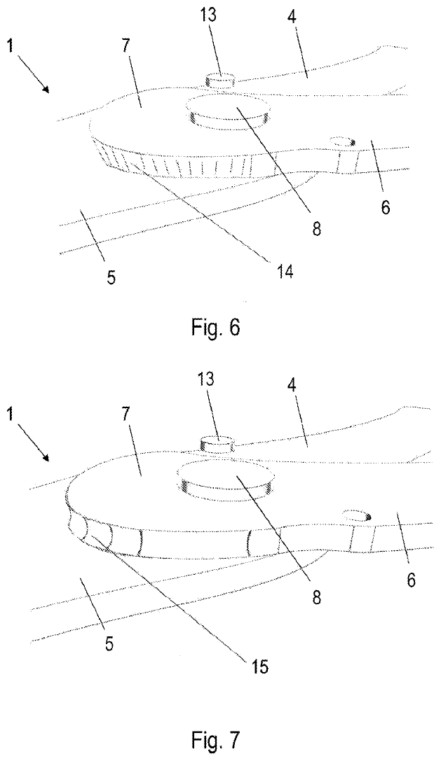

FIG. 6 shows the end region of the cutting tool of FIG. 1 in a first variant.

FIG. 7 shows the end region of the cutting tool of FIG. 1 in a second variant.

FIG. 1 shows a cutting tool 1, which is in particular used for cutting flat foodstuffs. It is to be mentioned, however, that the invention is not limited to this purpose of use. In particular, the cutting tool 1 may also be used for cutting paper, carton, cardboard, metal or the like, for which reason the cutting tool 1 may be by all means also made from other materials and/or in other dimensions.

It is clear from FIG. 1 that the cutting tool 1 comprises a first cutting element 2 and a second cutting element 3. The first cutting element 2 is composed of an upper blade 4 and a handle 5. The second cutting element 3 is composed of a lower blade 6 and a handle-free end region 7. The upper blade 4 and the lower blade 6 delimit an angle αᵣ and each have a cutting edge, which faces towards the respective other blade 4, 5.

The second cutting element 3 is mounted on the first cutting element 2 so as to be pivotable about an axis of rotation A, see FIG. 2. Mounting may, for example, be carried out by way of a screw 8, which is guided through the first cutting element 2 and the second cutting element 3 and is fastened, for example, at the side facing away from the screw head by means of a nut. The type of mounting, however, may be selected at will. The axis of rotation A is arranged between the upper blade 4 and the handle 5 or between the lower blade 6 and the end region 7, respectively. There may be used as a separation line between lower blade 6 and end region 7, for example, a line, which extends through the axis of rotation A and extends essentially orthogonally to the cutting edge of the lower blade 6. If the cutting edge is curved or bent, respectively, there may be used a central line of the cutting edge.

In order to achieve a simple cutting operation, the cutting tool 1 comprises a spring element 10, which is fastened at a first end 11 to the upper blade 4 and at a second end 12 to the lower blade 6. The spring element is, for example, configured as a curved wire and spreads apart the first and the second cutting element 2, 3 into the rest position depicted in FIG. 1, i.e. the spring element 10 exerts a force onto the lower blade 6 such that it will be pushed away from the upper blade 4.

In order to make it possible to cut foodstuffs or the like, the cutting tool 1 is gripped at the handle 5 and the lower blade 6 is placed onto a bottom B. Then the foodstuff to be cut is placed in-between the upper blade 4 and the lower blade 6, and there is applied a force F onto the first cutting element 2 such that the lower blade 6 moves due to the resistance of the bottom B against the spring force in the direction of the upper blade 4.

Fastening the first end 11 of the spring element 10 to the upper blade 4 may be realized in one embodiment in that a bolt 13 is mounted at the upper blade 4, for example, screwed therein. The first end 11 of the spring element 10 may be wound around the bolt 13, as is depicted in FIG. 1. The second end 12 of the spring element 10 may be hooked into a hole of the lower blade 6, as shown. There may, however, also be provided that the first end 12 as well as the second end 12 be wound around a bolt or hooked into a hole.

Due to pressure onto the lower blade 6 towards the upper blade 4, the lower blade 6 may be pivoted in regard to the upper blade 4 from the rest position into a closed position. FIG. 1 shows the lower blade 6 in the rest position, i.e. in the position pivoted outwards to the maximum. In this position, the upper blade 4 and the lower blade 6 enclose an angle of αᵣ. In the example depicted, αᵣ=40°.

FIG. 3 shows the lower blade 6 in an intermediate position, after it has been pushed from the rest position towards the closed position. In this intermediate position, the upper blade 4 and the lower blade 6 enclose an angle of α_{z}. In the example depicted, α_{z}=10°.

FIG. 4 shows the lower blade 6 ultimately in a closed position, after it has been compressed from the rest position against the spring force. In this closed position, there is usually not provided a gap between the cutting edges of the upper blade 4 and the lower blade 6 such that there is present an angle of α₀=0°.

The rest position of FIG. 1 is defined or delimited, respectively, by the fact that the end region 7 of the second cutting element 3 abuts to the spring element 10 in a position P1, see FIG. 1. Alternatively, the second cutting element 3 could also rest immediately upon the bolt 13 or there could be provided a separate stopping device, which defines the end position of the second cutting element 3.

The closed position of FIG. 4 is defined or delimited, respectively, by the fact that the lower blade 6 of the second cutting element 3 abuts to the spring element 10 in a position P2, see FIG. 4. In this way, the lower blade 6 does not impact immediately onto the bolt 14 in the case of a rapid turn of the lower blade 6 into the closed position, which would lead to loud noise. Depending on the embodiment, there could, however, also be provided that the lower blade 6 in the closed position will nevertheless rest upon the bolt 13 or at a separate, preferably non-metallic stopper.

In order to have a possibly compact configuration of the cutting tool 1, the spring element 10 is guided at least in part around the end region 7 of the second cutting element 3. The spring element 10 is preferably guided around the entire end region 7 such that the spring element 10 does not rest at all on that wide side of the end region 8 of the second cutting element 3, which faces away from the upper blade 4. As shown in FIG. 1, the spring element 10 only rests in that partial region T on the wide side of the lower blade 6 of the second cutting element 3, at which the second end 12 of the spring element 10 is fastened to the lower blade 6. Alternatively to the embodiment depicted, the second end 12 of the spring element 10 may also be fastened to that wide side of the lower blade 6, which faces the upper blade 4, such that the cutting tool 1 may be configured even more compact. Thus, there may preferably be provided that the spring element 10 does not rest on that wide side of the second cutting element 3, which faces away from the upper blade 4, at all.

The spring element 10 may furthermore be configured in a way such that the spring element 10 offers a lower resistance via a first cutting region to a cutting motion of the lower blade 6 than via a second cutting region. The first cutting region is defined as that cutting region, which is situated between the rest position (FIG. 1) of the second cutting element 3 and a predetermined angle α_{z}, which is depicted in FIG. 3. The second cutting region is defined as that cutting region, which is situated between rest position of the predetermined angle α_{z} (FIG. 3) and the closed position having the angle α₀ (FIG. 4).

FIG. 5 shows the cutting behaviour of such a spring element 10 in a diagram. Therein, the angle between the upper blade 4 and the lower blade 6 is indicated on the x-coordinate and a corresponding spring resistance in kg is indicated on the y-coordinate. It is obvious that the required force for moving the lower blade 6 by a determined angular degree towards the upper blade 4 is lower in the first cutting region between the rest position αᵣ and the predetermined angle α_{z} than in the second cutting region between the predetermined angle α_{z} and the closed position α₀.

In order to achieve the behaviour of the variable resistance, there is preferred that the spring element 10 assume in the first cutting region a distance to the end region 7, i.e. it is spaced apart from the end region 7, and that it abut to the end region 7 in the second cutting region. This behaviour is visible from the FIGS. 1, 3 and 4: In the rest position of FIG. 1, the spring element 10 is not in contact with the end region 7, whereby the lower lade 6 may be readily pushed towards the upper blade 4. Once the intermediate position of FIG. 3 is achieved, the spring element 10 will be in contact with the end region 7, whereby there will be present additional resistance, making it difficult to push the lower blade 6 towards the upper blade 4. This additional resistance is present until the lower blade 6 reaches the closed position of FIG. 4. The increased resistance of the closed position mainly serves to prevent any undesired noise. The increased resistance will preferably occur after 50% to 90%, preferably essentially 70%, of the cutting path from the rest position into the closed position have been reached, i.e. preferably α_{z}=0.3*αᵣ.

As an alternative thereto, the spring element 10 may be configured accordingly to achieve a variable resistance, without being required interaction with the end region 7, for example, if the spring element 10 has a variable cross-section and/or a corresponding curvature.

There is preferably used as a spring element 10 a curved wire having a diameter smaller than the thickness of the second cutting element 3, as is depicted in FIG. 2. In this way, the spring element 10 may be guided around the end region 7 of the second cutting element 3 in a manner such that it does not project beyond that wide side of the second cutting element 3, which faces away from the first cutting element 2.

In order for the spring element 10 to not slip off of the end region 7 when cutting using the cutting tool 1, there may be taken measures as shown in FIGS. 6 and 7.

In the embodiment of FIG. 6 the end region 7 is provided with a chamfered polish 14 such that the end region 7 is tapered towards the first cutting element 2. In this way, the spring element 10 will remain at the end region 7 even if the lower blade 6 is pushed towards the upper blade 4 and, hence, the spring element 10 to the end region 7. Alternatively, the end region 7 may be provided with a groove 15 extending along the periphery of the end region 7, as shown in FIG. 7. If the spring element 10 is pushed to the end region, this will securely be accommodated in the groove 15, not snapping off of the end region 7.

The material of the cutting tool 1 may be selected depending on the purpose of use. There is, for example, used as material for the first and the second cutting element 2, 3 metal, in particular stainless steel, or also a ceramic material, such that hygienic requirements for the cutting tool 1 may be met if this is used for cutting foodstuffs. The handle 5 of the first cutting element 2 may, in addition, be provided with two wooden or plastic components 16 (FIGS. 1 to 4) in order to obtain an ergonomic handle. Alternatively, the handle may also be accommodated in a tubular shell.

Also the dimensions of the cutting tool 1 may be freely chosen. The length of the first cutting element 2 is in a preferred embodiment 22 cm, wherein the lengths of the upper blade 4 and of the lower blade 6 may be each 7.5 cm, and the thicknesses of the first or second cutting element 2, 3, respectively, may be each 2 mm. In general, it is preferred that the length of the first cutting element 2 be between 10 cm and 30 cm, the lengths of the upper blade 4 and of the lower blade 6 each be between 4 cm and 12 cm and the thicknesses of the first or the second cutting element 2, 3, respectively, each be between 1 mm and 3 mm.

The lower blade 6 may further have a nose 17, which firstly aids in inserting a foodstuff to be cut in-between the lower blade 6 and the upper blade 4. If the nose 17, in addition, in the closed position of the lower blade 6 projects beyond the upper blade 4, as is shown in FIG. 4, then the nose 17 may be used as an auxiliary means to eliminate a jamming in the closed position. For this purpose, the cutting tool 1 may be inverted such that there may be exerted a force upon the nose 17 to separate the lower blade 6 from the upper blade 4.

In the FIGS. 1, 3 and 4, there are depicted curved blades 4, 6 or curved cutting edges of the blades 4, 6, respectively. This shape will enable that especially thick or multi-layered articles may be cut. The curved shape will in particular enable an especially efficient cutting of foodstuffs. In other embodiments, the blades 4, 6 or the cutting edges of the blades 4, 6, respectively, may also be configured in a straight manner. This will enable, in particular, cutting of thin articles such as paper, cloths or films. It shall be understood, hence, that the invention is not limited to a special shape of the blades 4, 6 or of the cutting edges, respectively.

1.-9. (canceled)

10. A cutting tool, comprising:
a first cutting element and a second cutting element, which is mounted on the first cutting element so as to be pivotable about an axis of rotation, wherein the first cutting element has an upper blade and a handle between which the axis of rotation is arranged, and the second cutting element has a lower blade and a handle-free end region between which the axis of rotation is arranged,
wherein the cutting tool also has a spring element, which is fastened at a first end to the upper blade and at a second end to the lower blade and spreads apart the first cutting element and the second cutting element into a predetermined rest position,
wherein the spring element is guided partially around the end region of the second cutting element,
wherein the spring element offers a lower resistance via a first cutting region to a cutting motion of the lower blade than via a second cutting region, and
wherein the first cutting region is situated between the rest position of the second cutting element and a predetermined angle and the second cutting region is situated between the predetermined angle of the second cutting element and the closed position of the second cutting element.

11. A cutting tool according to claim 10, wherein the spring element is guided around the entire end region.

12. A cutting tool according to claim 10, wherein the spring element assumes in the first cutting region a distance to the end region and in the second cutting region abuts to the end region.

13. A cutting tool according to claim 10, wherein the spring element is fastened to the upper blade in such a way that the lower blade abuts to the spring element in the closed position of the second cutting element.

14. A cutting tool according to claim 13, wherein the spring element is fastened to the upper blade using a bolt and wherein the spring element is situated between the lower blade and the bolt in the closed position of the second cutting element.

15. A cutting tool according to claim 10, wherein the end region of the second cutting element has a chamfering, by way of which the spring element is held at the end region.

16. A cutting tool according to claim 10, wherein the end region of the second cutting element has a groove, by way of which the spring element is held at the end region.

17. A cutting tool according to claim 10, wherein the lower blade has a nose at an end facing away from the axis of rotation, which nose in the closed position of the second cutting element projects beyond the upper blade.

18. A cutting tool according to claim 10, wherein the lower blade has a length of up to 12 cm.
